(19) United States
(12) Patent Application Publication
(10) Pub. No.: US 2016/0042668 A1
(43) Pub. Date: Feb. 11, 2016

(54) VEHICLE WIRE INSTALLATION DEVICES AND METHODS

(71) Applicant: International Engine Intellectual Property Company, LLC, Lisle, IL (US)

(72) Inventor: Tom Lee Sorensen, Naperville, IL (US)

(21) Appl. No.: 14/454,187

(22) Filed: Aug. 7, 2014

(51) Int. Cl. G09B 23/18; G06K 7/10

(52) U.S. Cl. CPC G09B 23/18; G06K 7/10297

(57) ABSTRACT

Devices and methods are disclosed for facilitating correct wiring installation into various vehicles and sections of vehicles. Wireless data transmitting devices are connected to the vehicles, with each wireless data transmitting device affecting the display of information regarding the correct wiring installation for the vehicle, or portion of vehicle, to which it is attached as that vehicle, or portion of vehicle, comes into proximity with the operator installing the wiring.

### FIELD

The disclosed embodiments pertain to wiring installation in vehicles.

### BACKGROUND

A motorized vehicle has to perform several functions, and to perform each of these functions a vehicle usually includes many electrical components such as a starter motor, headlights, cabin lights, an air conditioning compressor, a window motor, etc. A large vehicle, such as a commercial truck, therefore may include one or more power source(s), electrical controls and a variety of electrical components. A large number of wires may be required to allow the electrical components to be connected to the power sources and to the electrical controls. When a vehicle is assembled, the wires have to be laid and connected very accurately.

It is common for truck manufacturers to offer a variety of truck models, with each of the various truck models also allowing for customization such as by specifying certain unique components. Thus, a certain model truck may have a wide variety of variations which need to be produced to meet various customer requirements, and some or all of these variations may require different routing and/or connecting of wiring in the production process.

The operator in charge of the wire routing and connection operation has to make sure that the wires are laid out and connected in a proper way for each permutation of vehicle which may be presented to the operator for the wiring assembly portion of production. The operation of installing wires in a vehicle during the production process relies heavily on the skills and experience of the operator to ensure that the wires are routed and connected appropriately for each variation of vehicle which may be presented. Considering that, in a manufacturing line, the time dedicated for each operation is limited and that there may be a large number of variations of wiring configurations being presented to an operator in a given day, this may result in wiring being improperly laid and/or connected in a vehicle.

Trucks assembled with incorrect wiring configurations which may need to be re-wired before the truck can be shipped to a customer, that may result in lost profits due to reworking and/or there may be product failure issues associated with improper wiring. There is a desire to reduce the lost profits associated with improper wiring installations in vehicles.

### SUMMARY

In accordance with one embodiment, a device or apparatus is provided for facilitating correct installation of wiring by an operator into various vehicles having different wiring installation requirements. A first wireless data transmitting tag, such as an RFID tag, is attached to a first portion of the vehicle and contains information identifying the particular vehicle to which the wireless data transmitting tag is attached, and information identifying the portion of the vehicle to which the wireless data transmitting tag is attached. A wireless data receiving and reading device, such as an RFID reader, is provided which is suitable for reading the information on the first wireless data transmitting tag as the first wireless data transmitting tag comes into proximity with the wireless data reading device and generating a first visual display to the operator showing the proper wiring installation for the first portion of the particular vehicle in which wiring is to be installed. A second wireless data transmitting tag, such as a second RFID tag, may be attached to a second portion of the vehicle and contain information identifying the particular vehicle to which the wireless data transmitting tag is attached, and the portion of the vehicle to which the second RFID tag is attached. The wireless data reading device is suitable for reading the information on the second RFID tag as the second RFID tag comes into proximity with the RFID reading device and generating a second visual display to the operator showing the proper wiring installation for the second portion of the particular vehicle. Accordingly, the operator is automatically presented with a visual display showing the proper wiring configuration to be employed for each vehicle, and each portion of each vehicle, as those portions or sections of the vehicles come into the operator's workstation for wiring installation.

### DRAWINGS

The drawings described herein are for illustration purposes only and are not intended to limit the scope of the present disclosure in any way.

FIG. 1 is a display of a schematic view of an object having a plurality of components attached thereto and illustrating a first desired wire routing and connection pattern for the object;

FIG. 2 is a display of a schematic view of the object of FIG. 1 having the same plurality of components attached thereto as in FIG. 1 and illustrating a second desired wire routing and connection pattern for the object;

FIG. 3 is a display of a schematic view of a first portion of an object showing a desired wire routing and connection pattern;

FIG. 4 is a display of a schematic view of a second portion of the objection of FIG. 3 showing the desired wire routing and connection pattern for the second portion of the object of FIG. 1;

FIG. 5 is an example of an image which may be displayed to facilitate proper wiring of a section of a vehicle; and

FIG. 6 is an example of an image which may be displayed to facilitate proper wiring of the same general section of the vehicle as in FIG. 5, but showing another view to further clarify the proper three dimensional routing and connection points for the wiring of the illustrated section of the vehicle.

### DETAILED DESCRIPTION

The following description is merely exemplary in nature and is not intended to limit the present disclosure, application or uses. It should be understood that throughout the drawings, corresponding reference numerals indicate like or corresponding parts or features.

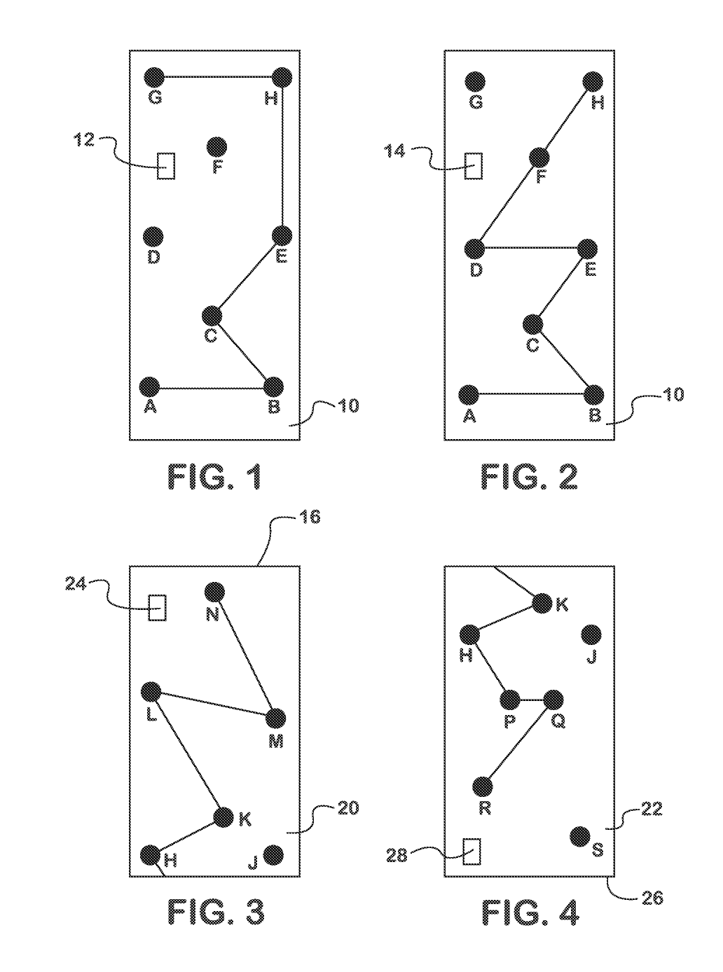

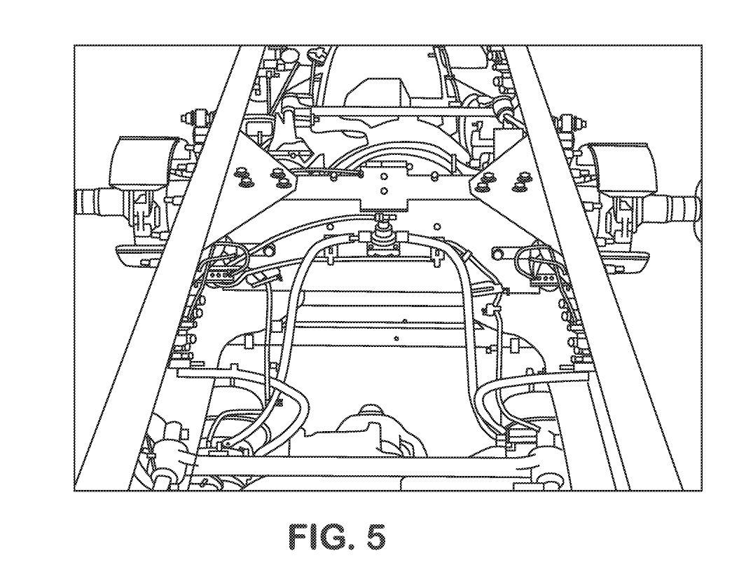

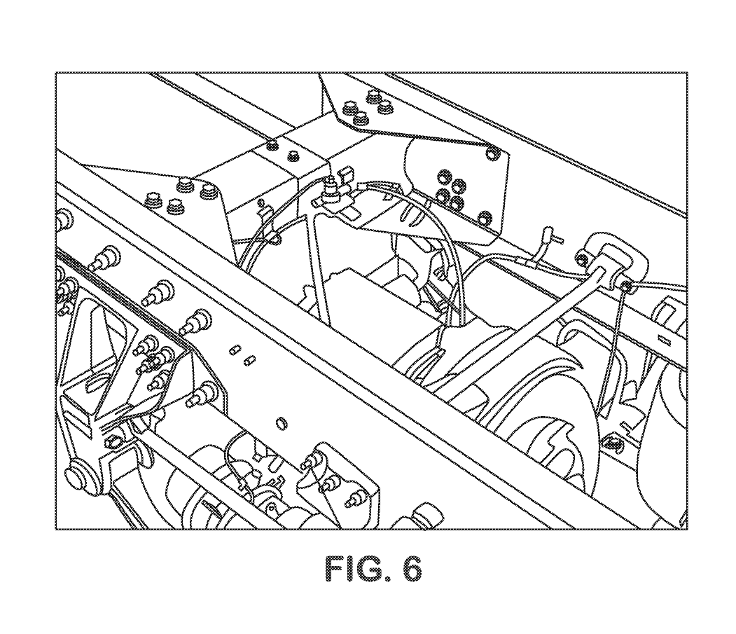

With initial reference to FIGS. 1 and 2, a first object 10 is illustrated having a plurality of components A-H (alternatively or additionally, any of points A-H may be components, or ground connection points, or wire anchor points, or other wire connection points, etc.) to which wires are to be routed and connected in different patterns depending on the product variation which is desired for a given application. Although aspects of embodiments set forth herein are discussed with regard to a vehicle, the object 10 may be a vehicle or may be any of a wide variety of other objects as well.

By way of example to illustrate one potential application, the object 10 of FIGS. 1 and 2 may be a truck having a battery A, radio B, electrically actuated air valve C, air conditioner D, headlights E, dome light F, electric cabin heater G and dashboard lights H. For the vehicle/object 10, of FIG. 1, the customer may have ordered a truck having all of features A-H except no air conditioner D and no dome light F; whereas for the vehicle/object 10 of FIG. 2, the customer may have ordered a truck having all of the features A-H except no electric cabin heater G.

In some instances and applications, all of the objects 10 may have the same components, but the customer or manufacturer may desire that only certain components be electrically connected, as illustrated in comparing FIGS. 1 and 2.

A factory may operate with a variety of similar, but differing, objects coming down the same assembly line and it may not be readily apparent to an operator what components a given object has which require wire routing and connections, and therefore not readily apparent what the correct routing and connection pattern is for each respective vehicle.

To facilitate accurate wire routing and connections for each object 10, wireless data transmitting devices such as RFID tags or the like may be utilized for indicating the proper wire routing and connection pattern for each object 10. For instance, a wireless data transmitting device or tag 12 may be attached to the object 10 of FIG. 1 which contains information for displaying the wiring pattern of FIG. 1 when the wireless data transmitting tag 12 comes into sufficient proximity with a wireless data transmitting detector 16. A different wireless data transmitting tag 14 may be attached to the object of FIG. 2 which contains information for displaying the wiring pattern of FIG. 2 when the wireless data transmitting tag 14 comes into sufficient proximity with a wireless data transmitting detector 16.

Accordingly, an RFID detector 16 and display device (which may be a hand-held display device, a heads-up display device, or a fixedly mounted display device) may be disposed in proximity to an operator situation on an assembly line, such that as a first object 10 and its associated RFID tag 12 attached thereto comes into sufficiently close proximity to the operator the display shows the correct routing and wiring pattern for that object to assist the operator with correct wiring installation. In the illustrated example of FIG. 1, the display shows the wiring extending from A-B-C-E-H-G. After the operator completes the wiring installation for that object 10, another of the same object 10 may come down the same assembly line which requires a different wiring installation. With a second RFID tag 14 attached to the object 10, as the object with the RFID tag 14 comes into sufficiently close proximity to the operator, the display may show a different wiring installation for the object 10, such as that shown in FIG. 2 which is A-B-C-E-D-F-H.

Some applications require the same objects to have a large variety of permutations of auxiliary equipment, optional features, and the like which make for a wide variety of desired wiring assembly patterns and it may be difficult for an operator to accurately remember all of the different wire routing and connection requirements for each of the different permutations. And it may be undesirably time consuming to locate and place on each object the correct paper drawings for each such permutation of wiring installation requirements for each object. Utilizing the RFID tags and associated display(s) as disclosed herein may facilitate faster and more accurate and wiring of objects.

FIGS. 3 and 4 illustrate an object having more than one section, with the wiring pattern of a first section being displayed when the wireless data transmitting tag attached to the first section of the object comes into sufficient proximity with the operator's wireless data transmitting reader—and then the wiring pattern of a second section being displayed when the wireless data transmitting tag attached to the second section of the object comes into sufficient proximity with the operator's wireless data transmitting reader. This allows for accurate wire routing and connecting of a large object to be broken down into smaller specific wire routing and connecting diagrams for an operator to follow sequentially.

For instance, with reference to FIG. 3 a wireless data transmitting tag 24 may be mounted to the object 20 near its front end 16. The RFID tag 24 may contain an address (VIN) and x/y coordinate which can bring up the correct drawing in a computer/network accessed server/database for the correct wiring diagram for the front end portion of the object 20. As the wireless data transmitting tag 24 comes into sufficiently close proximity with the wireless data transmitting reader, the display shows the correct wiring diagram for the front end portion of the object 20 (per the VIN and x/y coordinate location). In the illustrated example, this pattern is N-M-L-K-H.

With reference to FIG. 3 and wireless data transmitting tag 24 may be mounted to the object 20 near its front end 16, with the wireless data transmitting tag 24 containing the correct address/VIN/x-y coordinates to access the wiring diagram for the front end portion of the object 20. After the operator has connected the wiring as shown in the display for the front end portion of the object 20, and the rear end portion of the object 20 is brought into proximity with the operator and the wireless data transmitting reader the display shows the correct wiring diagram for the rear end portion of the object 20. As shown in FIG. 4, the diagrams for the various portions of the object 20 may overlap one another to provide additional guidance to the operator.

For instance, with reference to FIG. 4, the operator can see from the display of the rear portion of the object 22 that the wiring continues on from N-M-L-K-H on the front portion of the object 20 to P-Q-R on the rear portion of the object 22.

The displays may be two-dimensional, three-dimensional, schematic, perspective, elevated or other views, or any combinations thereof. Some displays may just show the routing path for the wiring with other displays showing the connection points for the wiring, or displays may show both routing and connection points and may include specific details of the connection, such as type of fasteners to use at various connection points or torque specifications. The displays may also show locations where wiring is to be affixed to the object to hold the wiring in place, and may show which fasteners are to be used for affixing the wiring to the object at those locations. The displays may also show the particular type of wiring or wiring harnesses to use for each application.

For vehicles such as trucks, an array of wireless data transmitting tags may be placed across a frame system which can allow wireless location and identification of specific points on the object. Each wireless data transmitting tag may be programmed with VIN and physical location information. An wireless data transmitting reader may work in conjunction with a tablet PC or other display device to read the wireless data transmitting tags and call up from a database (which may be located on a network or truck body controller for instance) a photo/image detail that is specific to the wireless data transmitting/frame viewing region. The photo images may be initially created from a certification pilot build, for instance, then loaded into a database to be accessed for use on each subsequent build. With the programmability of the tags, every job built can be identified as unique, as well as the specific frame locations on that job to accommodate the specific features of that particular truck. The disclosed concepts may also support field service to confirm proper installation of parts and wire harnesses on any part of the truck.

On a moving production line, with different job orders for line set in sequential order, assembly line and process engineers can access relevant data to each exact job, install, check, and adjust the installation in real time. The concepts of the disclosure may also be used to allow quick field inspection of commercial and military vehicles for safety, unauthorized alterations, and general condition.

The wireless data transmitting tags, or other wireless data transmitting devices, may be applied in a variety of ways. They may be temporarily applied to an object during production, and then removed at the end of production, for re-use in a subsequent production. The wireless data transmitting tags may be programmed in advance of being applied to the object, or may be programmed after being applied to the object. A plurality of wireless data transmitting tags may be programmed for each specific design to be built. For instance, a first plurality of wireless data transmitting tags may be programmed for the “standard version” of the object to be produced and placed on each object (or section of each object) to be built to the “standard version” specification. A second plurality of wireless data transmitting tags may be programmed for a “variation 1” version of the object to be produced, and placed on each object (or section of each object) to be built to the “first variation” design specification. A third plurality of wireless data transmitting tags may be programmed for a “variation 2” version of the object to be produced, and placed on each object (or section of each object) which is to be built to the “second variation” of the object to be built to the “third variation” version of the object to be produced. The wireless data transmitting tags may remain on the object which is to be sold commercially, or may be removed after production and re-used in subsequent productions.

The wireless data transmitting tags may be permanently attached to the object, such as by embedding the wireless data transmitting devices in bolts or the like which are connected to the object. Wireless date transmitting devices of the passive type, active type, or batter-assisted type may be utilized in various embodiments.

A wireless data reading and display system may be utilized in which a data reading device communicates with a separate display device, or a wireless data reading and display system may be utilized in which a single device both receives the wireless data information from the wireless data transmitting device and also displays an image or images. A wide variety of systems for reading and displaying wireless information are well known in the art and may be suitable for carrying out various embodiments.

While the embodiments disclosed in the specification mostly pertain to wire routing and connections in a truck or other vehicle, the disclosure is not limited to wire routing and connections on a vehicle and may be used in a wide variety of applications such as routing and connecting air hoses, pneumatic lines, fluid hoses, etc. and a wide variety of objects such as airplanes, motorcycles, dishwashers, refrigerators, etc.

Also, while the disclosure is set forth in terms of using wireless data transmitting tags, it will be readily apparent to those skilled in the art that any wireless data transmitting devices may be used instead of, or in addition to, wireless data transmitting tags for carrying out the concepts and disclosures set forth herein. Also, the display may be a head-up display, hologram, or other imaging devices.

The wireless data transmitting reader and the display may be a single combined device or may be two separate devices interconnected with one another either wirelessly or with wires.

The wireless data transmitting device need not contain or convey all of the information regarding proper wiring installation, and in fact it need not even contain any information regarding proper wiring installation. That is, in some embodiments, a library or map of various wiring installation information specific to different vehicles and/or different sections of vehicles, may be stored with the wireless data transmitting device sending a signal which is specifically assigned to one or more of the wiring installation instructions stored, so that when a given wireless data transmitting device comes into proximity with a wireless data receiving system it triggers the pulling up or displaying of suitable stored wiring information from the library or map on which it is stored, and this is displayed to the operator. So, for instance the wireless data transmitting device may merely transmit a unique signal (which may be, for instance a digit such as a 1, 2, 3, etc.) which is particular to a specific pre-stored diagram, such that when the wireless data transmitting reader receives say a “2” signal from the wireless data transmitting device it pulls up a predetermined image corresponding to the “2” signal; and when the wireless data transmitting reader receives say a “3” signal from the wireless data transmitting device it pulls up a different predetermined image corresponding to the “3” signal; and so on. Therefore, it is not necessary that any data other than some varying triggering signals be emitted from the respective wireless data transmitting devices and received by the wireless data transmitting readers.

Although the embodiments have been discussed with regard to electrical wiring, alternative embodiments and applications pertaining to installation of hoses, air lines, hydraulic lines, etc. may be carried out as well. This may be carried out at different stations along the production line. For instance, a given wireless data transmitting device may transmit a signal “4” and this signal brings up a wiring diagram on the wireless data receiving and display system at the wiring installation station to facilitate proper wiring installation; with the same “4” signal of the wireless data transmitting device triggering the bringing up of a hose installation diagram on the wireless data receiving and display system at the hose installation station to facilitate proper hose installation.

It will be readily apparent to those skilled in the art that numerous variations and modifications may be effected without departing from the spirit and scope of the disclosure herein. It is intended that the specification and examples be considered as exemplary only, with a true scope of the disclosure being indicated by the following claims and their equivalents.

What is claimed is:

1. A device for facilitating proper installation of wiring in a vehicle having at least a first portion and a second portion, the device comprising:
a first wireless data transmitting device attached to the first portion of the vehicle and containing proper wiring installation information specific to the first portion of the vehicle;
a second wireless data transmitting device attached to the second portion of the vehicle and containing proper wiring information specific to the second portion of the vehicle; and
an wireless data reading and display system suitable for reading the respective information of the first and second wireless data transmitting devices as the first and second wireless data transmitting devices respectively come into proximity with the wireless data reading and display device, to generate a first visual display containing information to facilitate proper wiring of the first portion of the vehicle when the first wireless data transmitting tag comes into proximity with the wireless data reading and display device and to generate a second visual display containing information to facilitate proper wiring of the second portion of the vehicle when the second wireless data transmitting device comes into proximity with the wireless data reading and display device.

2. A device in accordance with claim 1 in which the wireless data transmitting device comprises an RFID tag.

3. A device in accordance with claim 1 in which the wireless data transmitting devices are detachably removable from the vehicle for reuse of the wireless data transmitting devices on subsequent vehicles.

4. A device in accordance with claim 1 in which the wireless data reading and display device comprises a first component for receiving the wireless data information from the wireless data transmitting devices, and a second component operably connected with the first component for generating an image corresponding to the data which the first component receives from the wireless data transmitting device.

5. A device in accordance with claim 1 in which the information contained in one or more of the visual displays comprises images.

6. A device in accordance with claim 1 in which the information contained in one or more of the visual displays comprises text.

7. A device for facilitating installation of wiring by an operator into two or more vehicles having different wiring installation requirements:
a first wireless data transmitting device attached to a first vehicle;
a second wireless data transmitting device attached to a second vehicle;
a detector for detecting when the first wireless data transmitting device comes into proximity with the operator, and detecting when the second wireless data transmitting device comes into proximity with the operator; and
a display device operatively connected with the detector for displaying information about the wiring installation of the first vehicle as the first vehicle comes into proximity with the operator, and for displaying information about the wiring installation of the second vehicle as the second vehicle comes into proximity with the operator.

8. A device in accordance with claim 7 in which the first and second wireless data transmitting devices are RFID tags.

9. A device in accordance with claim 7 in which the first and second wireless data transmitting devices each transmit information pertaining to wiring of respective first and second vehicles.

10. A device in accordance with claim 7 in which different wiring instructions specific to each of the respective vehicles are stored on an electronic storage medium, with the first and second wireless data transmitting devices triggering the pulling up of respective wiring instructions from the electronic storage medium on the display device.

11. A device in accordance with claim 7 in which the detector is in proximity with the operator.

12. A method of installing wiring on a vehicle, comprising:
providing a first wireless data transmitting device containing information specific to proper wire installation of a first model of vehicle;
mounting the first wireless data transmitting device on the first model of vehicle;
providing a second wireless data transmitting device containing information specific to proper wire installation of a second model of vehicle;
mounting the second wireless data transmitting device on the second model of vehicle;
providing a wireless data transmitting device reader and display suitable for reading the first and second wireless data transmitting devices as they are respectively brought into sufficient proximity with the wireless data transmitting device reader and displaying wire installation information specific to the respective wireless data transmitting device which is in proximity to the wireless data transmitting device reader;
bringing the first model of vehicle with the first wireless data transmitting device mounted thereto into sufficient proximity with the wireless data transmitting device reader to display wire installation information specific to the first model of vehicle;
installing wiring on the first model of vehicle in accordance with the information displayed specific to the first model of vehicle;
bringing the second model of vehicle with the second wireless data transmitting device mounted thereto into sufficient proximity with the wireless data transmitting device reader to display wire installation information specific to the second model of vehicle; and
installing wiring on the second model of vehicle in accordance with the information displayed specific to the second model of vehicle.

13. The method of claim 12 in which the wireless data transmitting device reader and display comprises a wireless data transmitting reader and a separate display device operatively interconnected.

14. The method of claim 12 in which the wireless data transmitting devices comprise RFID tags.

15. The method of claim 12 in which the RFID tags are active RFID tags.
